(19) United States
(12) Patent Application Publication
(10) Pub. No.: US 2008/0085727 A1
(43) Pub. Date: Apr. 10, 2008

(54) SYSTEM AND METHOD FOR DETERMINING MOBILE DEVICE POSITION INFORMATION

(76) Inventor: Tyler M. Kratz, Pleasant Valley, IA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/697,682

(22) Filed: Apr. 6, 2007

Related U.S. Application Data
(60) Provisional application No. 60/813,344, filed on Jun. 14, 2006.

(51) Int. Cl. H04Q 7/20; H04M 1/00

(52) U.S. Cl. 455/456.5; 455/552.1

(57) ABSTRACT

A mobile device positioning system is disclosed. In one embodiment, the positioning system uses a plurality of independent communication beacons to triangulate mobile device locations. In one embodiment, mobile devices broadcast their location to other mobile devices which use the mobile device broadcasts to triangulate their location.

### CROSS-REFERENCE TO RELATED APPLICATIONS

The present application claims priority benefit under 35 U.S.C. § 119(e) to U.S. Provisional Patent Application Ser. No. 60/813,344, filed Jun. 14, 2006, titled “System and Method for Communicating Position Information via Mobile Devices,” the entirety of which is incorporated herein by reference.

### FIELD OF THE INVENTION

The present invention relates to the field of communications and more particularly to communication of information by mobile devices operating wirelessly.

### BACKGROUND

Recent advances in hardware and communication technologies have brought about the proliferation of powerful mobile devices ranging from notebook computers to much smaller personal digital assistants (PDAs) and cell phones that operate over wireless networks using radio frequency (RF) links. These mobile devices operate on various platforms, such as Palm computing platform, Windows CE, etc. Other types of mobile devices include paging and messaging devices, laptop computers, data-capable smart phones, etc. These devices can provide users with network access connectivity which allows users to be quickly notified of changing events, and provide them with the resources necessary to respond even when in transit. In this way, users can be given the power to access mission critical information in a quick and reliable manner.

Current mobile device location systems generally operate based on either a Global Positioning System (GPS) or a Radio Frequency (RF) triangulation system using carrier antenna tower (CAT) signal information. However, GPS only works in environments where a line of sight is available to a sufficient number of GPS satellites. Thus, GPS often does not work in environments where the receiving antenna is indoors, such as, for example, inside a car, house or building. Other common obstructions such as high buildings and trees prevent direct lines of sight to GPS satellites also. In addition, GPS requires additional hardware including an independent radio with an oscillating crystal. GPS also does not work well at high latitudes. Some countries outlaw or limit the use of GPS. In addition, the RF triangulation system using CATs are accurate only to about 100 feet, primarily because of the relatively long distances between CAT towers.

### SUMMARY

Aspects of the present disclosure include an independent network of communication devices which are used to provide accurate and real-time information regarding mobile device location information without requiring a line of sight to a satellite or other transceiver. In one embodiment, a plurality of relatively small wireless communication transceivers are set up throughout an area of interest. The plurality of wireless transceivers communicate with the mobile devices within the area of interest independent of the carrier network towers. Information regarding mobile device location is compiled either from the independent antennas or from the mobile devices via a network connection and used to analyze traffic conditions, suggest traffic routes, track specific mobile device locations, etc. In one embodiment, GPS and RF triangulation enabled mobile devices communicate secondary location information in order to increase accuracy of location measurement. In one embodiment, historic traffic conditions, weather, the date, and event information are used in conjunction with real time traffic information to predict traffic patterns. In one embodiment, the plurality of wireless communication transceivers provides network (e.g. Internet) access to the mobile devices. In one embodiment, some or all of the mobile devices act as beacons broadcasting their location to other mobile devices. In one embodiment, the plurality of wireless transceivers use software defined radio (“SDR”) to communicate with the mobile devices. In one embodiment the mobile devices use SDR. In one embodiment, the plurality of mobile devices act as an independent antenna broadcasting their position information to other mobile devices. In one embodiment, the mobile devices act as repeaters transmitting data and information from mobile device to mobile device to a predetermined destination.

In one embodiment, a system for determining location information of a plurality of mobile devices is disclosed. The system includes a plurality of stationary antennas configured to broadcast information indicative of the antennas location, a first mobile device which receives the information indicative of the antennas location and determines a location of the first mobile device. In one embodiment, the first mobile device broadcasts information indicative of the location of the first mobile device directly to a second mobile device. In one embodiment, a second mobile device receives the information indicative of the location of the first mobile device directly from the first mobile device and determines a location of the second mobile device based in part on the information indicative of the location of the first mobile device.

In one embodiment, a central processor receives information regarding the location of a plurality of mobile devices. In one embodiment, the central processor determines traffic patterns based on the received information. In one embodiment, the central processor determines an optimal travel route to a desired location for a user. In one embodiment, the central processor sends travel route information to the user. In one embodiment, the mobile devices are one of a PDA, portable computer; pager, or mobile telephone.

In one embodiment, a method of determining the location of a mobile device is disclosed. The method includes the steps of receiving, at a first mobile device, location information indicative of a location of a stationary antenna, determining a location of the first mobile device, and broadcasting the location of the first mobile device directly to a second mobile device. In one embodiment, the method includes the step of receiving at a second mobile device the broadcasted location of the first mobile device directly from the first mobile device. In one embodiment, the method includes the step of determining a location of the second mobile device based at least in part on the received location of the first mobile device. In one embodiment, the broadcast is on an unlicensed spectrum. In one embodiment, the broadcast is on a licensed spectrum.

In one embodiment, a mobile device is disclosed. The mobile device includes a receiver which receives wireless signals representative of location information of a plurality of transmitters, a processor which determines a location of the mobile device based on the signals representative of location information of the plurality of transmitters, and a transmitter which transmits the location of the receiver directly to a second mobile device. In one embodiment, the receiver is reconfigurable to receive signals from different communication protocols. In one embodiment, the receiver is reconfigurable using software. In one embodiment, the transmitter is reconfigurable to transmit signals using different communication protocols. In one embodiment, the transmitter is reconfigurable using software. In one embodiment, the broadcast is on an unlicensed spectrum. In one embodiment, the broadcast is on a licensed spectrum.

In one embodiment, a system for determine the location of a mobile device is disclosed. The system includes a plurality of stationary antennas operating independently of wireless carrier networks. The plurality of antennas broadcast location information indicative of the location of the antennas. The broadcast locations are configured to be received by a mobile device and used to determine the location of the mobile device. In one embodiment, the plurality of antennas broadcast on an unlicensed spectrum. In one embodiment, the unlicensed spectrum includes one or more of 700 MHz, 900 MHz, 2.3 GHz, 2.4 GHz, 3.5 GHz, 5.3 GHz or 5.8 GHz. In one embodiment, a central station receives information indicative of the location of the mobile device. In one embodiment, the central station determines travel route information based on the location of the mobile devices. In one embodiment, the central station communicates the travel route information to a user.

### BRIEF DESCRIPTION OF THE DRAWINGS

FIG. 1 is an illustration of an embodiment of a wireless communication system.

FIG. 2 is an illustration of another embodiment of a wireless communication system.

FIG. 3 is an illustration of yet another embodiment of a wireless communication system.

FIG. 4 is an illustration of an embodiment of an independent antenna system.

FIG. 5 is an illustration of an embodiment of an SDR system.

FIG. 6 is a flowchart illustrating an embodiment of a mobile device communication procedure.

FIG. 7 is a flowchart illustrating an embodiment of a travel route identification procedure.

FIG. 8 is a flowchart illustrating an embodiment of a system for determining mobile device location using the mobile devices as a mobile broadcasting antenna.

### DETAILED DESCRIPTION

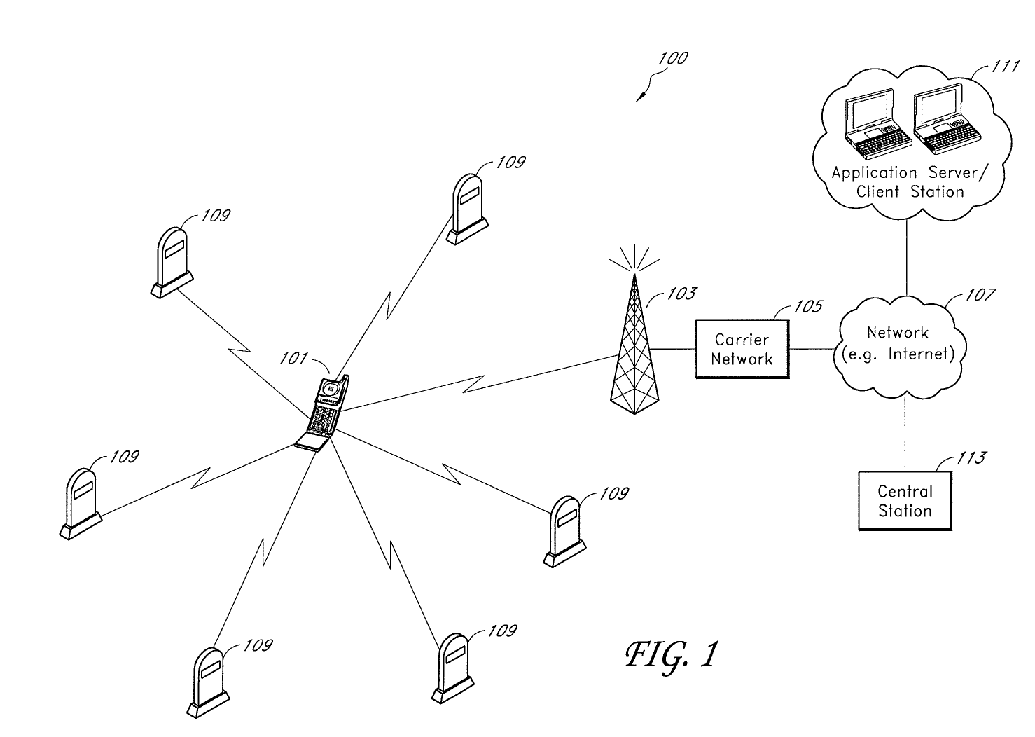

FIG. 1 is a diagram for a system 100 that supports wireless communication among a plurality of mobile devices 101, a wireless carrier network 105 and a plurality of independent antenna systems (IASs) 109. A mobile device 101 operating within the wireless system 100 can be any suitable wireless device, such as, for example, cell phones, personal digital assistants (PDAs), phones, smart phones, pagers, laptops, cars, or the like. In one embodiment, the mobile device is a tracking device, such as, for example, embedded in a car, a laptop, a child's watch, shoes, clothing, or the like. Carrier networks 105 include cellular communications networks which are designed to provide voice and data communications to mobile devices. Examples of such networks include wireless carrier networks operated by such wireless service providers as Sprint Nextel, Verizon Wireless, Cingular Wireless, and so forth. The wireless carrier network 105 includes carrier antenna towers (CATs) 103 that communicate RF signals with the mobile devices 101 in accordance with a defined protocol over suitable wireless links, such as those defined under GSM, GPRS, EDGE, W-CDMA, OFDM, WiFI, IS-136, IS-95, iDEN, or the like. Generally, communications going through the CATs 103 are subject to the terms of the service agreement between a mobile device user and the wireless service provider.

The users of the mobile devices 101 generally have subscription agreements for various services with their corresponding wireless service providers, including voice, data or Internet access services, or the like. In general, one of the supported services of the wireless carrier network 105 includes data communications service, which allows the mobile devices to exchange data with a central station or application server 111 according to the terms of the service provider agreement. Data can include, such as, for example, uploadable and downloadable software, files and user profiles to and from the mobile devices 101, including software that controls the operation of the mobile devices or the like. The data exchange with the mobile devices can take place over any supported proprietary or standard transport layer, link, wired or wireless-physical connection to the central station/application server either directly or via any collection of interconnected (public and/or private) networks that are linked together by a set of standard or proprietary protocols. The transport protocol can be any suitable protocol, including TCP/IP, or any of various wired or wireless transport protocols, or the like.

In one embodiment, the application server station or client stations 111 are wirelessly linked to the mobile devices 101 over a network 107, such as, for example, the Internet. In addition, a central station 113 compiles information related to the system and location of the mobile devices and controls the operation of the IASs 109. The application server and/or central station can access a database, which stores various data, including user profiles of the mobile devices.

As stated above, the wireless system 100 also includes a plurality of IASs 109 that communicate RF signals with the mobile devices independent of the CATs 103 and the wireless carrier network 105. As a result, mobile device communications with the IASs 109 are not subject to the terms of the wireless service provider agreement. As further described below, the IASs 109 are used for providing various services to the mobile device users, such as positioning and navigation services, independent of or in conjunction with the wireless service provider that operates the wireless carrier network 105.

FIG. 1 illustrates an embodiment in which the IASs are beacons which transmit a signal on an unlicensed spectrum, such as, for example, 900 MHz, 2.3 GHz, 2.4 GHz, 3.5 GHz, 5.3 GHz, 5.8 GHz, and so on. In one embodiment, each IAS 109 sends out a signal at a short time interval indicating a unique identification code. In one embodiment, the IASs transmit on licensed spectrums. The mobile device 101 receives the IAS signals which reach the mobile device 101 and tracks both the identification code and signal strength. In one embodiment, the mobile device 101 performs the triangulation calculation itself and then sends its location through the carrier network 105 to the central station 113. In one embodiment, the mobile device transmits each IAS identification code and signal strength through the carrier network 105 to the central station 113 for calculation.

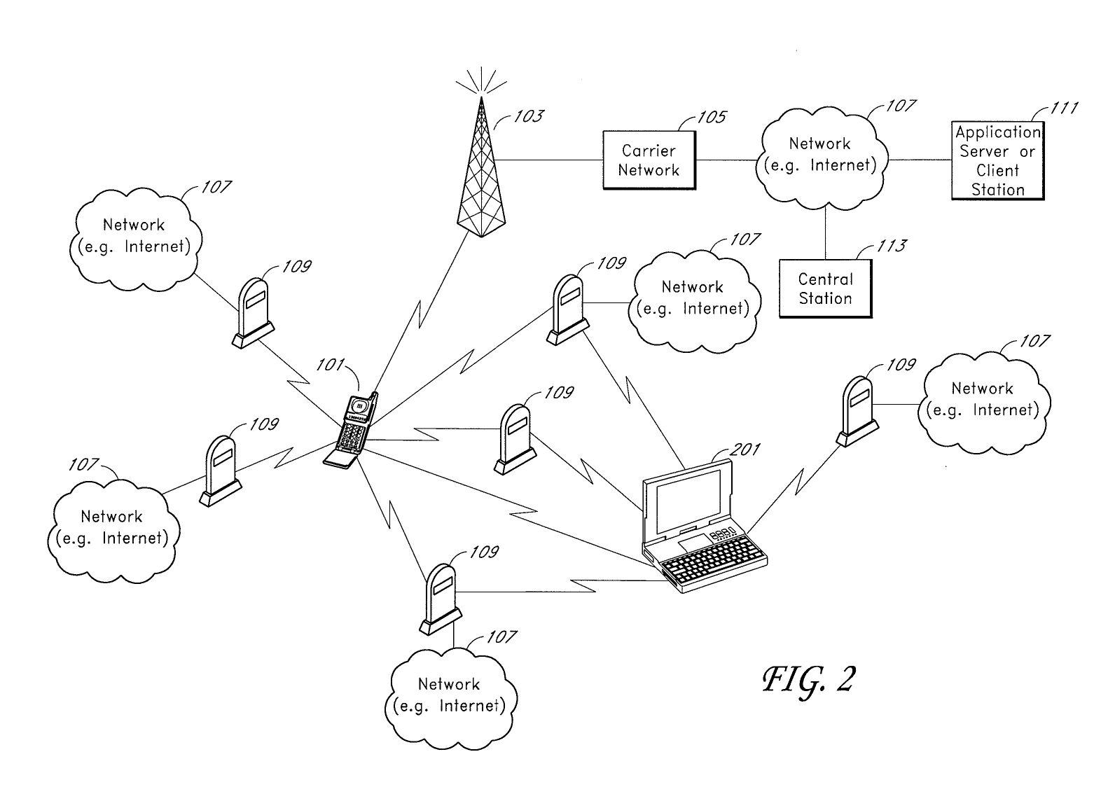

FIG. 2 illustrates an embodiment in which the IASs 109 are linked to a network (e.g., the Internet). The IASs 109 can communicate with the network through a wired or wireless communication, such as, for example, a microwave link, Ethernet, telephone, Bluetooth, or the like. In this embodiment, the IASs 109 both transmit and receive information from the mobile devices 101, as well as from other sources, such as the network. In addition to operating like a beacon, the IASs 109 can track mobile device 101 identification and signal strength and report that information to the central station 113 through the network connection. In one embodiment, the central station performs the triangulation calculation and reports the calculation back to the mobile device 101 through the carrier network 105 or through the IASs 109.

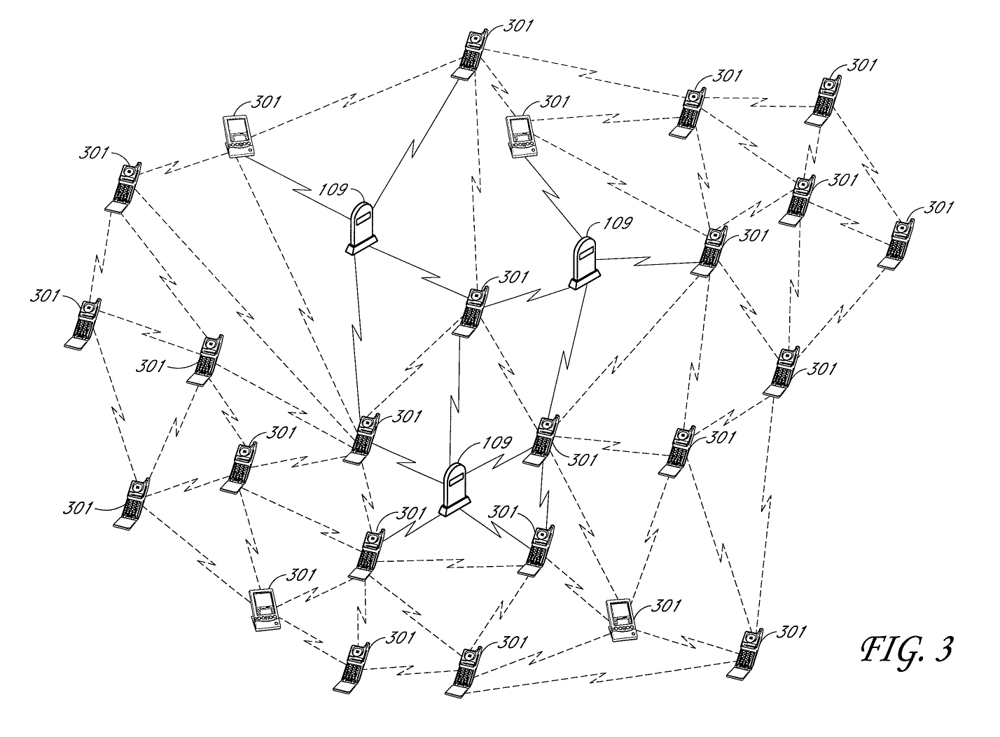

FIG. 3 illustrates an embodiment in which some or all of the mobile devices 301 act as a mobile IAS in order to increase network bandwidth, allow for more accurate location calculations and/or provide a network requiring less stationary IASs. In this embodiment, in addition to the mobile devices 301 receiving location information from the stationary IASs, the mobile devices also broadcast their location information which can be received by other mobile devices 301 and used to determine the location of the other mobile devices 301. The mobile devices 301 thus act like mobile IASs. In one embodiment, because the mobile devices are effectively mobile IASs, fewer IASs are required for accurate location information and effective bandwidth. This significantly reduces the cost of the system.

For example, in one embodiment, three stationary IASs are set up in an area of interest. Using these three or more stationary IASs, the positions of mobile devices within range are found. The mobile devices then become IAS in that they broadcast their current location. Other mobile devices within range of the transmitting mobile devices can also be located. As more mobile devices transmit their locations, more mobile devices can determine their location. The more mobile devices that transmit their location, the more accurate the system becomes. In this way, as few as three stationary IAS are used in a much larger area of interest in order to accurately determine location information. In one embodiment, delivery personnel, such as, for example, postal workers, package delivery personnel, or the like, have mobile devices, such as cellular phones, which transmit their location information for other non-transmitting mobile devices to use to determine their location. In one embodiment, the mobile devices also transmit their locations to a central station. In one embodiment, the mobile devices transmit their location to a central station either through a carrier network or through an IAS 109.

In one embodiment, the mobile devices 301 can be used by the central station 113 to increase network bandwidth by communicating directly with other mobile devices 301. For example, in one embodiment, a first mobile device 301 can be instructed by the central station 113 to share files directly with a second mobile device 301, thereby lowering the demand on communication bandwidth between the central station 113 and the mobile device 301. In one embodiment, the central station 113 orchestrates a communication network through the use of mobile devices that can effectively circumvent the carrier networks by using cell phone communications with other cell phones to transmit data. Such a mobile device communication system is similar to the World Wide Web in which communication is passed through various servers until it arrives at the correct location. Similarly, data from one mobile device 301 can be passed to other mobile devices 301 until the data reaches its intended destination.

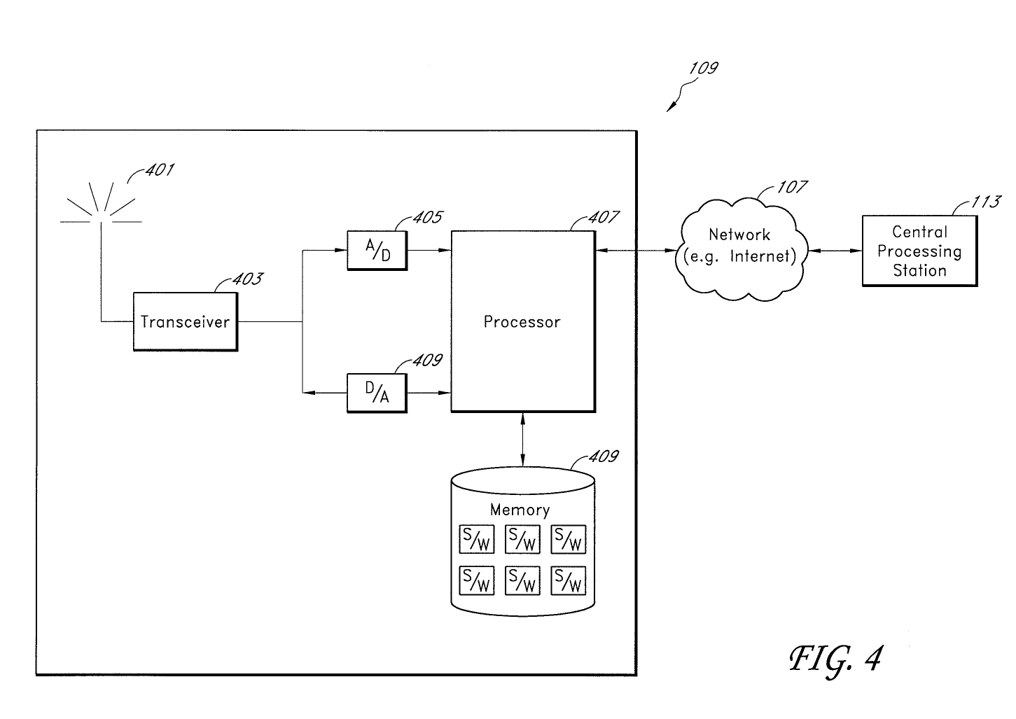

FIG. 4 illustrates a simplified block diagram of an IAS 109. Each IAS, includes at least one or more antennae 401 and corresponding radio receivers, and if necessary transmitters (e.g., transceiver 403), as well as a programmable processor 407 for processing the signals from the mobile devices 101. An analog to digital converter 405 and a digital to analog converter 409 are also included in order to transmit information between the transceiver 403 and the processor 407. The processor 407 communicates with memory 409. As described above, the processor 407 can also be used to calculate the location of the mobile device 101. The processor of the IAS 109 executes a program for generating a suitable radio platform for the IAS to enable it to communicate with the mobile devices according to a defined protocol in compliance with regulatory requirements.

In one embodiment, at least some of the mobile devices 101 and/or the IASs 109 are enabled with a technology that allows their radio platform to be configured as applicable across a wide range of standardized, or proprietary, wireless communication protocols. One such technology is Software Defined Radio (SDR). SDR, sometimes referred to as software radio, refers to wireless communication in which the transmitter and receiver modulation is generated or defined by software using a processor. SDR devices can tune to different frequencies of interest and receive and/or send at different modulation frequencies. In other words, SDR devices can be statically and dynamically reconfigured using software to receive signals of interest at various frequencies and modulations. Devices utilizing SDR can hop around the spectrum transmitting and receiving data. This provides significant versatility to a mobile transceiving device.

SDR-enabled mobile devices 101 and/or IASs 109 can be statically or dynamically programmed in software to reconfigure the characteristics of their respective hardware to dynamically accommodate various specified wireless communication requirements and protocols. This is achieved through the use of a set of Application Programming Interfaces (API)s residing on top of a flexible hardware layer. Such SDR enabled mobile devices and/or IASs can be equipped with smart antenna technology such as beam-forming algorithms, DSP/FPGA techniques, to accommodate a wide variety of wireless applications, protocols and standards. In this way, the same hardware can be modified to perform different functions at different times. SDR enabled-mobile devices and/or IASs provide software control of a variety of modulation techniques, wide-band or narrow-band operation, communications security functions (such as hopping), and waveform requirements of current and evolving standards over a broad frequency range.

In one embodiment, SDR is integrated into a mobile device 101 and/or IAS 109. In another embodiment, SDR is incorporated into an accessory device, such as, for example, USB, Firewire, Bluetooth, or the like, that interfaces with the mobile device 101 and/or IAS 109 via a suitable port. The mobile devices and IASs can become operationally compatible, that is, for reception and transmission of RF signals, either statically (e.g., pre-programmed or hardwired) or dynamically (e.g., through downloadable programs that dynamically configure either or both the mobile devices or IASs to compatible communication modes). Through proper programming of one or both SDR-enabled mobile devices or IASs, both the mobile devices and IASs can be configured to communicate with each other over a proprietary or non-proprietary wireless link, which is regulatory compliant.

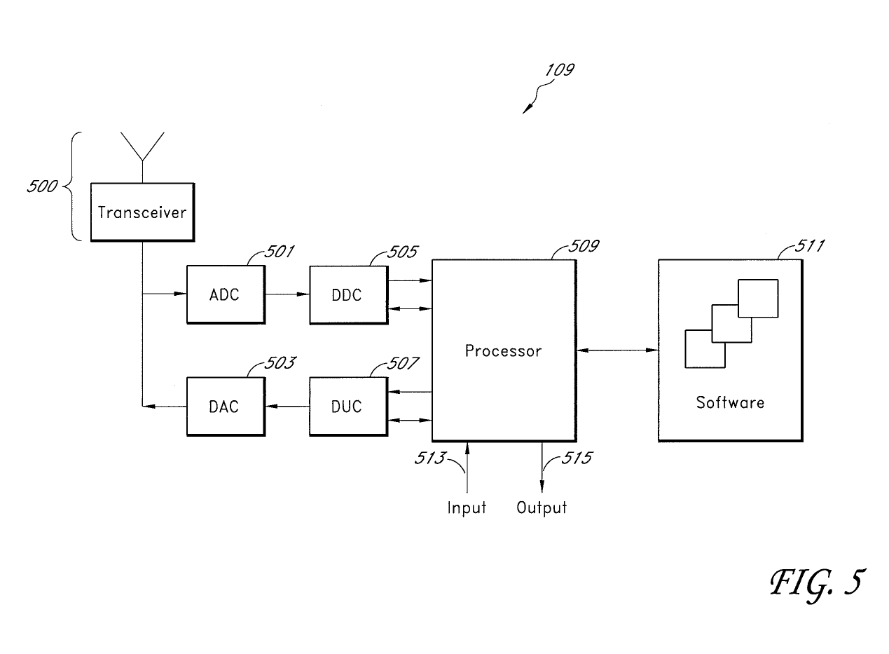

FIG. 5 illustrates an embodiment of an IAS enabled with SDR technology. The IAS includes an antenna and transceiver 500, an analog to digital converter (ADC) 501, a digital to analog converter (DAC) 503, a digital down converter (DDC) 505, a digital up converter (DUC) 507, a processor 509, memory 511 including software modules, and various other inputs 513 and outputs 515. The antenna and transceiver 500 receive and send wireless communications. The ADC 501 converts received communications from analog to digital values. The DAC 503 converts communications that will be sent from digital to analog values. The DDC 505 digitally mixes the desired signal to an intermediate frequency for processing by the processor 509. The processor 509 processes, sends and receives wireless communications. In addition, the processor 509 communicates with other resources, such as the central station 113, or a user input/output device over the inputs and outputs 513, 515. Memory 511 including software modules provide the processor with the software needed to coordinate sending and receiving information. The processor 509 and software modules can also be used to reprogram the DDC 505 and the DUC 507 depending on the type of signals to be received and sent.

According to one embodiment, the mobile devices execute position tracking (PT) software that enables each device to transmit to the IASs all of the necessary information, including identification information, for determining the position of the mobile device. In one embodiment, the PT software can be downloaded to the mobile devices 101, to enable the mobile device to transmit position information and identification (ID) information for reception, demodulation and decoding by the IASs.

In one embodiment, the PT software includes SDR software that enables the mobile device to operate in a suitable communication mode that is compatible with the communication mode of the IASs. The transmitted mobile device position information and ID information are received at the IAS for further mobile device position determination processing. In one embodiment, the mobile devices registers the signal strength of each IAS with which it is in communication and either determines its position via a software program on the mobile device, or transmits the registered signals to a central processing station for position computation. In an embodiment in which the mobile device calculates its own position, the mobile device is further configured to transmit its position information to a central processing station. Mobile device position information comprises any information that relates to the position of the mobile device relative to a suitable reference, including such as, for example, received signal strength information (RSSI), GPS data, cell/micro-cell ID data, network ID data, carrier network location data, or the like. In one embodiment, the IASs send out a relatively small “ping” made up of a relatively small packet. This allows for low bandwidth and low battery use requirements.

The PT software can be either non-configurable by the user or it can allow the user to set the parameters for transmitting the mobile device position and ID information. In one embodiment, the PT software enables the mobile device to transmit position information to the IASs at defined intervals, thereby enabling the IASs to receive such position information in a timely manner. The central station 113 can configure the reception mode of the IASs 109 to be compatible with that of the transmission mode of the mobile devices for receiving the position information within their coverage area in compliance with government regulatory requirements, such as those set forth by the FCC in the US.

According to one embodiment, triangulation of RF signals transmitted from the mobile devices 101 at reception points of one or more IASs 109 is used to provide mobile device position information. More specifically, the central station can alert a plurality of IASs 109 to listen to data transmission from a mobile device. When at least three IASs (or greater for more accurate computation) receive the mobile device position and ID transmissions, they measure the relative received signal strength for triangulation data processing, either locally at the IASs 109 or centrally at the central station 113. Based on received raw data, triangulation calculations are used for determining the position of the mobile devices 101 relative to a reference coordinate system.

The mobile device position and ID information transmission can occur at 800 MHz, 1900 MHz, 2.5-2.7 GHz or any other ISM band (e.g., 2.4 or 5 GHz range) as well as the AWS and 700 MHz spectrum or any other licensed or unlicensed spectrums. In one embodiment, the IAS. 109 at each independent antenna site are spaced much closer than the CATs 103 of the wireless carrier network 105 and therefore provide more accurate position information. The IASs 109 can be placed close to each other by locating the IASs at various private establishments (e.g. local restaurants, stores, businesses, homes, etc.) scattered within a geography or government controlled structures such as, for example, traffic lights or telephone poles. The positioning information provided by the mobile devices can be supplemented with GPS information, such as, for example, in rural areas, or outside of areas where IAS's are located, when transmitting mobile device position information.

In one embodiment, the users of the mobile devices 101 can gain access to the PT software by interfacing with the Application server 111 serving a web site. The PT software can be supplied to the mobile devices 101 via any communication routes, including downloading of the software for transfer to the mobile devices 101 or direct transmission from the central station 113 or application server 111 to the mobile devices 101 over a wireless link. User access to the PT software can be conditioned on terms set forth by an application service provider (ASP) that utilizes the mobile device position information for enabling various applications. In one embodiment, the ASP creates incentives for a critical mass of users to execute the PT software in their mobile device 101. The users can be incentivized to use the PT software in their mobile devices, for example, by being offered a free service, such as a navigation service, with or without advertising. In return, the users agree to provide their position information to the ASP. In one embodiment, the mobile device position information collected at the IASs from the mobile devices are integrated and processed for traffic patterns analysis. In one embodiment, commercial drivers, such as, for example, postal delivery drivers, truck drivers, etc. can be incentivized to use the PT software in their mobile devices.

More specifically, the ASP analyzes the mobile device position information received from a critical mass of mobile devices to determine traffic pattern information of the mobile devices within a service area. As part of the traffic pattern analysis, the ASP can determine the relative speed of each mobile device by storing a previous location and time for a particular mobile device and comparing it to a current location and time. Mobile device location and relative speed can be assimilated into current traffic information by mapping mobile device location and speeds to roadways. In addition, mobile device location information can also be used to determine congestion at public locations, such as malls, restaurants, beaches, parks, etc. Current traffic pattern information can be combined with historic traffic information, weather, the date, and local events to predict future traffic patterns. The traffic pattern information derived from such analysis is then used to provide real time route information for reaching one or more destinations from one or more departure points. The traffic pattern information, for example, can be used to find the fastest route for delivery of multiple items within the service area. The resulting traffic information is offered as a service to make delivery of items and persons more efficient. For example, in a situation where multiple stops throughout a day are required, the system can use historic and real time traffic, weather information, the date and local events to form an optimized travel route for multiple locations. In one such scenario in which deliveries need to be made to points A, B, C, D, and E, the system may suggest delivering to these locations out of order. For example, due to traffic congestion from B to C, the driver will be rerouted to D. From D, the software may tell the driver to go to A because all routes to A will become very congested later according to historic traffic patterns. Examples of businesses that benefit from real time traffic information service offered by the ASP include couriers, taxi cabs, caterer, etc. In order to provide the best route, the traffic pattern analysis would take into account current travel conditions as well as historical traffic patterns, e.g., weekday/weekend, time of day, weather etc, to enhance the efficiency of determining the best route.

In one embodiment, a delivery person scans address information for delivery of the items to be delivered. Such address information are provided to the central station 113, which analyzes them against traffic pattern analysis derived based on mobile device position information received at the IASs 109 in real time. The resulting real time route information (e.g., the best route for delivery of the next item, is transmitted to the mobile device). Such route information can be updated periodically based on real time analysis of traffic in view of constantly arriving mobile device position information.

In one embodiment, once position information is collected, it can be used in a variety of different applications. For example, in one embodiment of an application, mobile device users have the option of allowing others to view their location. For example, in one embodiment, a mobile device user may authorize another mobile device user to view their location on the other user's mobile device. For example, in one embodiment, a map with the first user's location may open in a window on the second user's device. In one embodiment, a mobile device user may authorize another user to obtain their location information on a webpage or via a phone or fax message request.

In one embodiment, the location information is used to provide localized advertising. For example, advertisers can pay to have virtual coupons appear or pop up in a side screen, asking people to patronize their establishments as they walk by the store. In one embodiment, advertisers pay a certain amount to access information about anonymous users and then tailor their ads to certain behavior. A local coffee shop can pay to find out which anonymous users pass by their shop every morning and end up at a different coffee shop. Advertisers can purchase this list and then send a free coupon to the mobile device to entice the mobile device user to patronize their establishment as they pass. Of course, other advertising uses are also possible.

In one embodiment, IAS can be positioned in confined areas, such as, for example, malls, airports, shopping districts, amusement parks, historical areas, museums, or the like. In addition to providing location information, the system can also be used to provide guide information, historical information, services information, or the like. The IAS can be located in or near a point of interest, such as, for example, a store or museum exhibit. As the user passes the exhibit, the mobile device is prompted to provide information, coupons, advertisements, etc. to the user's mobile device.

In one embodiment, mobile or temporary IASs can be used to provide position information. For example, IASs can be temporarily located in locations of interest and then moved when the area of interest moves. For example, mobile IASs can be used in military or emergency applications in locations where permanent IASs have not been set up. For example, in one application, mobile IASs can be used in military applications to provide a redundant system to GPS or as an alternative to GPS. This is desirable because GPS transmissions can be jammed and a secondary location system can provide redundant and reliable information. In addition, given the ability to quickly and automatically change broadcasting and modulation frequencies, it is very difficult to consistently jam an IAS signal without jamming all signals which would harm an enemy's ability to communicate. In one embodiment, the IASs can be located on a plane located high above or on vehicles on the ground. In one embodiment, IAS frequencies can be determined through encrypted algorithms. In addition to the mobile IASs, mobile devices used by military personal can also broadcast their location information as described above.

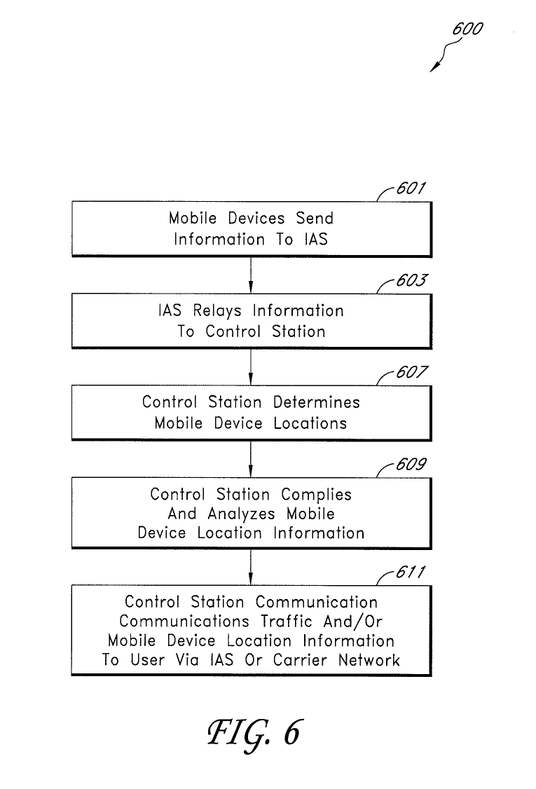

FIG. 6 is a flowchart illustrating one embodiment of a system 600 which provides communication of location information with a mobile device 101. In the system 600, the mobile devices 101 send ID, signal strength, and location information to one or more IASs 109. The IASs 109 relay the information to a central station 113 at block 603. The central station 113 then determines each mobile device's location at block 607. At block 609, the central station compiles and analyzes the mobile device location information to create, such as, for example, comprehensive traffic information, population density information, individual device location or travel information or the like. At block 611, the system 600 communicates information back to the mobile device through the IASs 109 or carrier network 105.

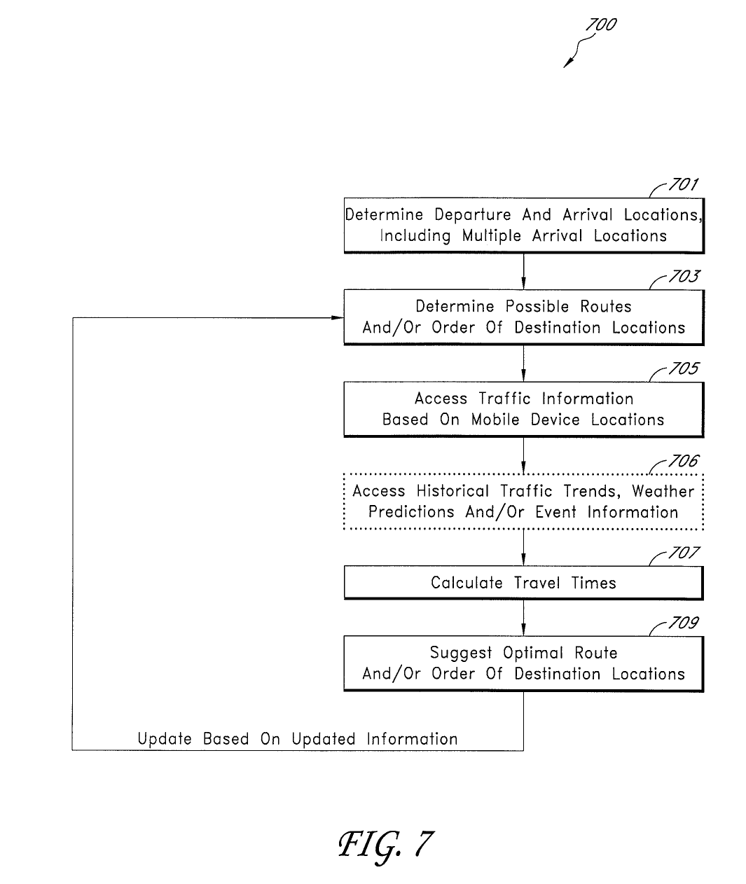

FIG. 7 is a flowchart illustrating one embodiment of a system for obtaining and transmitting traffic information. The system 700 first determines a departure and arrival location, including multiple arrival locations at block 701. The system 700 then moves to block 703 where a plurality of possible routes are determined, including routes for arriving at multiple destination points in different orders. At block 705, the system 700 accesses real time traffic information based on the plurality of possible routes. Optionally, at block 706, the system 700 also accesses historical traffic trends, weather predictions and/or even information. Travel times are then calculated for each route at block 707. At block 709, the system 700 then determines the routes with the lowest travel time and transmits the route information to the mobile device 101. In one embodiment, the system 700 transmits all of the routes and travel times for all of the routes to the mobile device so that the user can choose which route they would prefer to take. In one embodiment, the system 700 continuously updates routes and travel times while the mobile device is in route and suggests alternative routes as conditions change. In one embodiment, the process 700 communicates turn by turn voice and graphics to guide a mobile device user to their destination.

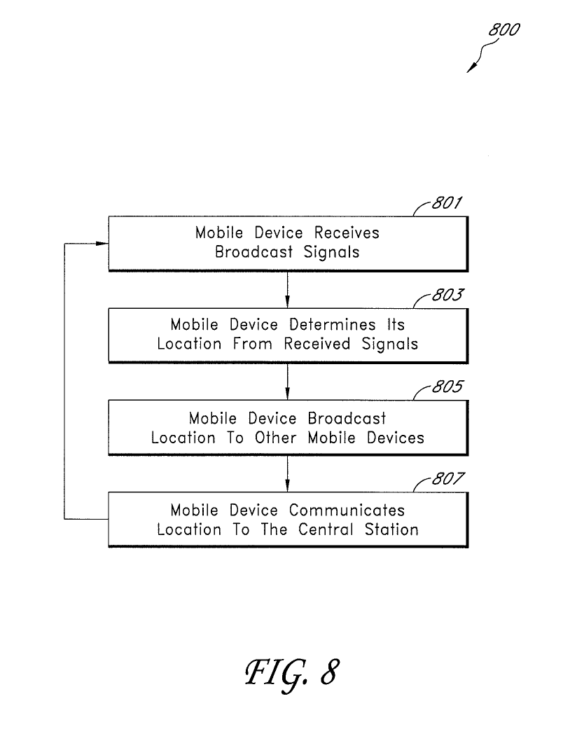

FIG. 8 is a flowchart illustrating one embodiment of a system 800 for determining mobile device locations using the mobile devices as mobile IASs. At block 801, the mobile device receives broadcast signals relevant to determining location information. The signals can be broadcast from, such as, for example, another mobile device, a stationary IAS, a CAT, a GPS satellite or the like. The system 800 then moves to block 803 where the mobile device determines its location from the received signals. The system 800 then moves to block 805 where the mobile device broadcasts its location to other mobile devices. At block 807, the mobile device communicates its location to the central station. The mobile devices can communicate with the central station through a carrier network, through a stationary IAS, through another mobile device, or in various combinations of the foregoing, or in any other convenient way. The system 800 then repeats itself in order to continuously update its location.

Although the foregoing invention has been described in terms of certain preferred embodiments, other embodiments will be apparent to those of ordinary skill in the art from the disclosure herein. For example, a skilled artisan will recognize from the disclosure herein that various methods of manufacture, design, and materials can be used with the present disclosure. Additionally, other combinations, omissions, substitutions and modifications will be apparent to the skilled artisan in view of the disclosure herein. It is contemplated that various aspects and features of the invention described can be practiced separately, combined together, or substituted for one another, and that a variety of combination and subcombinations of the features and aspects can be made and still fall within the scope of the invention. Furthermore, the systems described above need not include all of the modules and functions described in the preferred embodiments. Accordingly, the present invention is not intended to be limited by the recitation of the preferred embodiments, but is to be defined by reference to the appended claims.

What is claimed is:

1. A system for determining location information of a plurality of mobile devices comprising:
a plurality of stationary antennas configured to broadcast information indicative of the antennas location;
a first mobile device configured receive the information indicative of the antennas location and to determine a location of the first mobile device;
wherein the first mobile device is further configured to broadcast information indicative of the location of the first mobile device directly to a second mobile device;
a second mobile device configured to receive the information indicative of the location of the first mobile device directly from the first mobile device and to determine a location of the second mobile device based in part on the information indicative of the location of the first mobile device.

2. The system of claim 1, further comprising a central processor configured to receive information regarding the location of a plurality of mobile devices.

3. The system of claim 2, wherein the central processor is further configured to determine traffic patterns based on the received information.

4. The system of claim 3, wherein the central processor is further configured to determine an optimal travel route to a desired location for a user.

5. The system of claim 4, wherein the central processor is further configured to send travel route information to the user.

6. The system of claim 1, wherein the first mobile device comprises a mobile telephone.

7. The system of claim 1, wherein the second mobile device comprises a mobile telephone.

8. The system of claim 1, wherein at least one of the first or second mobile devices comprise one or more of a PDA, portable computer; pager, and mobile telephone.

9. A method of determining the location of a mobile device comprising:
receiving, at a first mobile device, location information indicative of a location of a stationary antenna;
determining a location of the first mobile device; and
broadcasting the location of the first mobile device directly to a second mobile device.

10. The method of claim 9, further comprising receiving at a second mobile device the broadcasted location of the first mobile device directly from the first mobile device.

11. The method of claim 10, further comprising determining a location of the second mobile device based at least in part on the received location of the first mobile device.

12. A mobile device comprising:
a receiver configured to receive wireless signals representative of location information of a plurality of transmitters;
a processor configured to determine a location of the mobile device based on the signals representative of location information of the plurality of transmitters; and
a transmitter configured to transmit the location of the receiver directly to a second mobile device.

13. The mobile device of claim 12, wherein the receiver is reconfigurable to receive signals from different communication protocols.

14. The mobile device of claim 13, wherein the receiver is reconfigurable using software.

15. The mobile device of claim 12, wherein the transmitter is reconfigurable to transmit signals using different communication protocols.

16. The mobile device of claim 14, wherein the transmitter is reconfigurable using software.

17. A system for determining the location of a mobile device comprising:
a plurality of stationary antennas operating independently of a wireless carrier network; the plurality of antennas configured to broadcast location information indicative of the location of the antennas;
wherein the broadcast locations are configured to be received by a mobile device and used to determine the location of the mobile device.

18. The system of claim 17, wherein the plurality of antennas are further configured to broadcast on an unlicensed spectrum.

19. The system of claim 18, wherein the unlicensed spectrum comprises one or more of 900 MHz, 2.3 GHz, 2.4 GHz, 3.5 GHz, 5.3 GHz and 5.8 GHz.

20. The system of claim 17, further comprising a central station configured to receive information indicative of the location of the mobile device.

21. The system of claim 20, wherein the central station is configured to determine travel route information based on the location of the mobile devices.

22. The system of claim 21, wherein the central station is configured to communicate travel route information to a user.
